(19) United States
(12) Patent Application Publication
(10) Pub. No.: US 2015/0332624 A1
(43) Pub. Date: Nov. 19, 2015

(54) SIGNAL FREQUENCY SETTING DEVICE AND METHOD FOR TIME SCHEDULE CONTROLLER AND DISPLAY DEVICE

(71) Applicants: BOE Technology Group Cp., Ltd., Beijing (CN); Hefei Hinsheng Optoelectronics Technology Co., Ltd, Anhui (CN)

(72) Inventor: Yanping Zhang, Beijing (CN)

(21) Appl. No.: 14/647,998

(22) PCT Filed: Sep. 17, 2014
(86) PCT No.: PCT/CN2014/086711

§ 371 Date: May 28, 2015

(30) Foreign Application Priority Data
May 13, 2014 (CN) 201410200339.6

(51) Int. Cl. G09G 3/20; H04W 24/10

(52) U.S. Cl. CPC G09G 3/2096; H04W 24/10; G09G 2370/14; G09G 2310/08; G09G 2300/0413

(57) ABSTRACT

The present invention provides signal frequency setting devices and method for a time controller of a display device. The device comprises a frequency setting module configured to set a signal frequency of a time controller for the display device to a fixed value with is independent from a low voltage differential signal of the time controller for the display device. Meanwhile, the present disclosure further discloses a signal frequency setting method for a time controller of a display device. According to the present disclosure, even if the clock frequency of the frontend LVDS signal changes, the clock frequency of the signal of the backend time controller will not be affected; meanwhile, one PLL circuit is omitted for the whole system circuit so as to decrease the cost.

This application is a Section 371 National Stage Application of International Application No. PCT/CN2014/086711, filed 17 Sep. 2014, entitled “SIGNAL FREQUENCY SETTING DEVICE AND METHOD FOR TIME CONTROLLER AND DISPLAY DEVICE, which has not yet published, which claims priority to Chinese Application No. 201410200339.6, filed on May 13, 2014, are incorporated herein by reference in their entirety.

### TECHNICAL FIELD

The present invention relates to technical field of Wireless Wide Area Network and more particularly, to signal frequency setting devices and methods for a time controller of a display device, so as to effectively avoid wireless wide area network noise (WWAN noise).

### BACKGROUND

At present, a third generation (3G) communication technique has been developed. Wireless wide area network is a hot spot for 3G application, which facilitates a notebook computer or other application devices may be connected to Internet within scopes covered by Cellular network. However, electromagnetic interference in working frequency band for WWAN is always a difficult problem which obfuscates manufactures of the display device and the notebook system terminal. For example, a radiated and conducted electromagnetic interference seriously affect properties of the display device, leading to the display device and other electronic device equipped with the display device have a poor WWAN characteristic. In order to guarantee communication quality so that data can be correctly transferred, it is desirable to avoid a specific frequency band or to decrease a level of the electromagnetic interference at a specific frequency range for wireless application.

A high frequency signal applied to a digital circuit module on a printed circuit board (PCB) of the display device applied for WWAN greatly interferes external electromagnetic transmission, especially for a low-voltage differential signal (LVDS) and a miniature low-voltage differential signal (mini-LVDS) in the display device, as can been seen from actual WWAN test results. In an actual WWAN test, a primary WWAN noise occurred in interested frequency range of WWAN is generated by higher harmonics due to LVDS or mini-LVDS. The characteristic for the interested frequency range of WWAN is that there is a frequency multiplication relationship between the interested frequency range and the LVDS or mini-LVDS signals. That is to say, the frequency range of the WWAN noise is an integral multiple of the frequency of the LVDS or mini-LVDS signals.

A principle for generating a WWAN noise is as follows: a clock signal is generated by a constant current source at the system side, transmitted through a signal line and transferred to a time schedule control chip in a display device driving circuit. The LVDS signal and the mini-LVDS belong to a high frequency signal. The frequency of the LVDS signal is generally about 69 MHz-75 MHz, and the frequency of the mini-LVDS signal is generally about three times of that of the LVDS signal. Since these signals are not fully absorbed, it is possible for them to be reflected along the propagation path. The reflected signal and the propagated signal eventually interact with each other to form a standing wave of a high frequency. These standing waves of high frequency converts wiring of the propagation path to be an antenna with a high efficiency for radiating outwards, which becomes noise in the interested frequency range of WWAN. That is to say, since the existing terminals can't eliminate reflections of the LVDS signal and the mini-LVDS signals of the time controller along the transmission path, so that the WWAN noise is generated.

### SUMMARY

In order to solve the above problem, the present disclosure provides signal frequency setting devices and methods for a time controller of a display device.

According to one aspect of the present disclosure, there is provided a signal frequency setting device for a time controller of a display device comprising: a frequency setting module configured to set a signal frequency of the time controller for the display device to a fixed value which is independent from a low voltage differential signal of the time controller for the display device.

Preferably, the signal frequency setting device further comprises a measuring module configured to actually measure noise of a wireless wide area network outside of an interested frequency range of the wireless wide area network, and to obtain a plurality of candidate frequency values outside of the interested frequency range of the wireless wide area network from a waveform of the noise of the wireless wide area network; and a frequency selecting module configured to select an optimal frequency value among the candidate frequency values as a fixed value according to a predefined noise threshold.

According to another aspect of the present disclosure, there is provided setting signal frequency method for a time controller of a display device comprising: setting a signal frequency of a time controller for the display device to a fixed value which is independent from a low voltage differential signal of the time controller for the display device.

Preferably, the method further comprises, prior to setting the signal frequency, actually measuring noise of the wireless wide area network outside of an interested frequency range of the wireless wide area network, and obtaining a plurality of candidate frequency values outside of the interested frequency range of the wireless wide area network from a waveform of the noise of the wireless wide area network; and selecting an optimal frequency value among the candidate frequency values as the fixed value according to a predefined noise threshold.

According to the present disclosure, even if the clock frequency of the frontend LVDS signal changes, the clock frequency of the signal of the backend time controller is kept not to be changed without being affected by the frequency of the frontend LVDS signal; the WWAN noise is decreased by actually measuring noise of the wireless wide area network outside of an interested frequency range of the wireless wide area network and selecting a fixed frequency value on the basis of the noise; meanwhile, one PLL circuit is omitted for the whole system circuit by fixing the frequency of the low voltage differential signal of the time controller, so as to decrease the cost.

### BRIEF DESCRIPTION OF THE DRAWINGS

FIG. 1 is a schematic diagram showing a basic structure of TFT-LCD driver;

FIG. 2 is a schematic diagram showing a function of converting TCON signal;

FIG. 3 is a flowchart illustrating a signal frequency setting method for a time controller according to the present invention;

FIG. 4 is a schematic diagram showing structure of a PLL circuit;

FIG. 5 is a schematic diagram showing a dual-gate design solution;

FIG. 6 is a schematic diagram showing a comparison of time schedules of a conventional design and a dual-gate design; and

FIG. 7 is a signal waveform obtained by inserting various front-dummy signals and back-dummy signals.

### DETAILED DESCRIPTION OF THE EMBODIMENTS

The present invention will be further in detail illustrated by reference to the accompany drawings in conjunction with the particular embodiments so that the object, technical solution and advantages of the present invention become apparent.

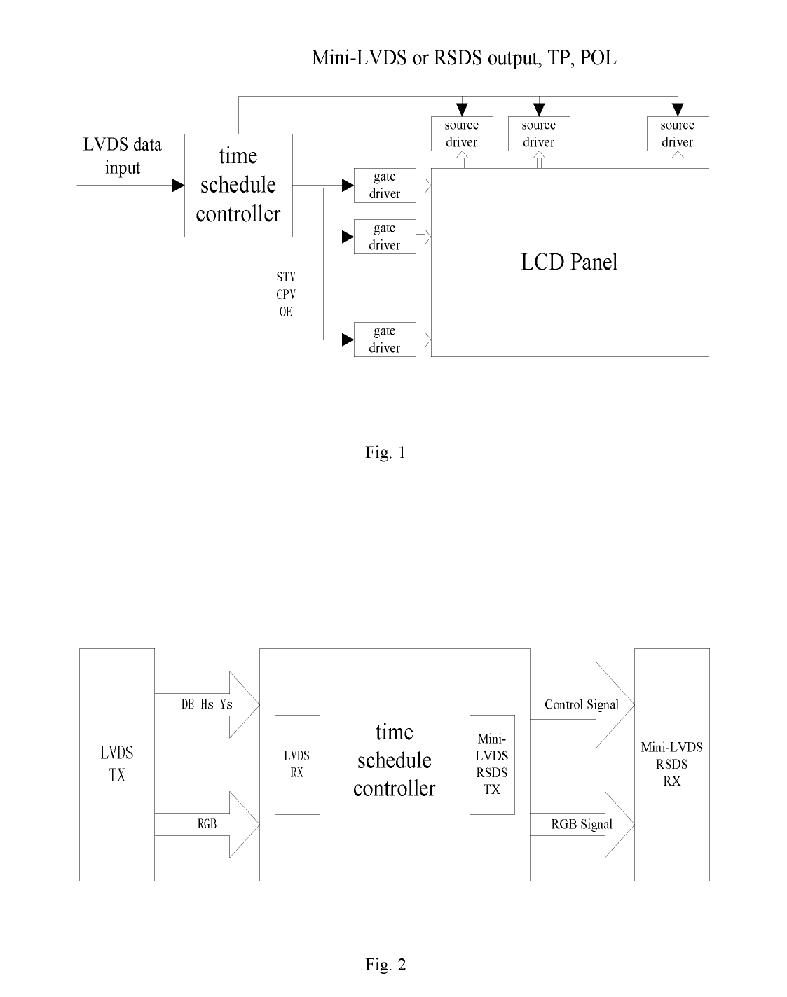

At present, a print circuit board is an important component of a display device such as a liquid crystal display, and a time controller (TCON) is a most important component of the print circuit board, which may convert a frontend LDVS signal into a mini-LVDS signal and generate a control signal to be provided to a driver circuit (driver IC) so as to guarantee that the display device may effectively and orderly operate, as shown in FIG. 1. The conversion from the LVDS signal to the mini-LVDS signal is shown by the schematic diagram showing a function of converting TCON signal of FIG. 2.

As mentioned above, a signal transmitted from a frontend system (e.g. LVDS signal) is converted to be another high frequency signal (such as mini-LVDS signal) by TCON. For most of the present notebook computers, an operating frequency of the mini-LVDS signal is generally three times of that of the frontend signal, that is: LVDS CLK Frequency=[(Output Pair num)*(Output port num)*2]/Mini-LVDS CLK Frequency/[(Input CLK Port num)*(color bit num*3)], wherein LVDS CLK frequency represents a clock frequency of the LVDS signal; Output Pair number represents the number of the output data pair, the value of which is 3; Output port num represents numbers of the output ports, the value of which is 2; Mini-LVDS CLK frequency represents a clock frequency of the Mini-LVDS signal; Input CLK port number represents numbers of the input clock ports, the value of which is 1; and color bit num represents numbers of the color bits, the value of which is 3 for RGB.

From the above equation, it may be calculated to get a relationship in which the clock frequency of the LVDS signal is three times of that of the mini-LVDS signal.

As mentioned above, the WWAN noise is mostly originated from the mini-LVDS signal and the conventional TCON signal, and the frequency of the mini-LVDS signal changes along with the change of frequency of the frontend LVDS signal. Thus, it is difficult for the frequency of the mini-LVDS signal to keep away from the interested frequency range of the WWAN noise, so the WWAN noise is generated.

On the basis of the above mentioned contents, the present invention avoids WWAN noise by eliminating relationship between the clock frequency of the LVDS signal and that of the signal of the time controller. In particularly, the clock frequency of the signal of the time controller is set to be a fixed value and is kept not to be changed, no matter how the clock frequency of the frontend LVDS signal changes. Thus, the WWAN noise can be reduced so as to always guarantee that the display device operates normally.

According to one aspect of the present invention, there is provided a signal frequency setting device for a time controller of a display device. The signal frequency setting device may comprises: a frequency setting module configured to set a signal frequency of a time controller for the display device to a fixed value with is independent from a low voltage differential signal of the time controller for the display device.

Furthermore, the signal frequency setting device may further comprise: a measuring module configured to actually measure noise of the wireless wide area network outside of an interested frequency range of the wireless wide area network, and to obtain a plurality of candidate frequency values outside of the interested frequency range of the wireless wide area network from a waveform of the noise of the wireless wide area network; and a frequency selecting module configured to select an optimal frequency value among the candidate frequency values as the fixed value according to a predefined noise threshold.

The aim of the measuring module is to obtain a plurality of candidate frequency values outside of the interested frequency range of the wireless wide area network which can't generate a WWAN noise, so that the signal frequency for the time controller of the display device may be modified.

The noise threshold in the frequency selecting module may be set according to actual application and is not limited in the present invention.

The signal frequency setting device is configured to set the signal frequency of the time controller by setting the number H blank of the blank pixels along the horizontal direction of the display device and the number V blank of the blank pixels along the vertical direction of the display device. In addition, the frequency setting module adjusts the number of the blank pixel by setting the number of a front-dummy signal and a back-dummy signal within one line of signals.

According to another aspect of the present invention, there is provided a signal frequency setting method for a time controller of a display device. As shown in FIG. 3, the signal frequency setting method for a time controller comprises setting a signal frequency of a time controller for the display device to a fixed value with is independent from a low voltage differential signal of the time controller for the display device.

Furthermore, the signal frequency setting method, prior to setting the signal frequency, may further comprise: actually measuring noise of the wireless wide area network outside of an interested frequency range of the wireless wide area network, and obtaining a plurality of candidate frequency values outside of the interested frequency range of the wireless wide area network from a waveform of the noise of the wireless wide area network; and selecting an optimal frequency value among the candidate frequency values as the fixed value according to a predefined noise threshold.

The aim of the step of noise measuring is to obtain a plurality of candidate frequency values outside of the interested frequency range of the wireless wide area network which can't generate a WWAN noise, so that the signal frequency for the time controller of the display device may be modified.

The predefined noise threshold may be set according to actual application and is not limited in the present invention.

By utilizing a signal frequency setting method for a time controller according to the present invention, the clock frequency of the signal of the backend time controller is kept to be the optimal frequency value no matter how the frequency of the frontend LVDS signal changes, and is not changed along with the change of the signal frequency of the LVDS signal, so as to effectively avoid the interested frequency range of the wireless wide area network noise (WWAN noise).

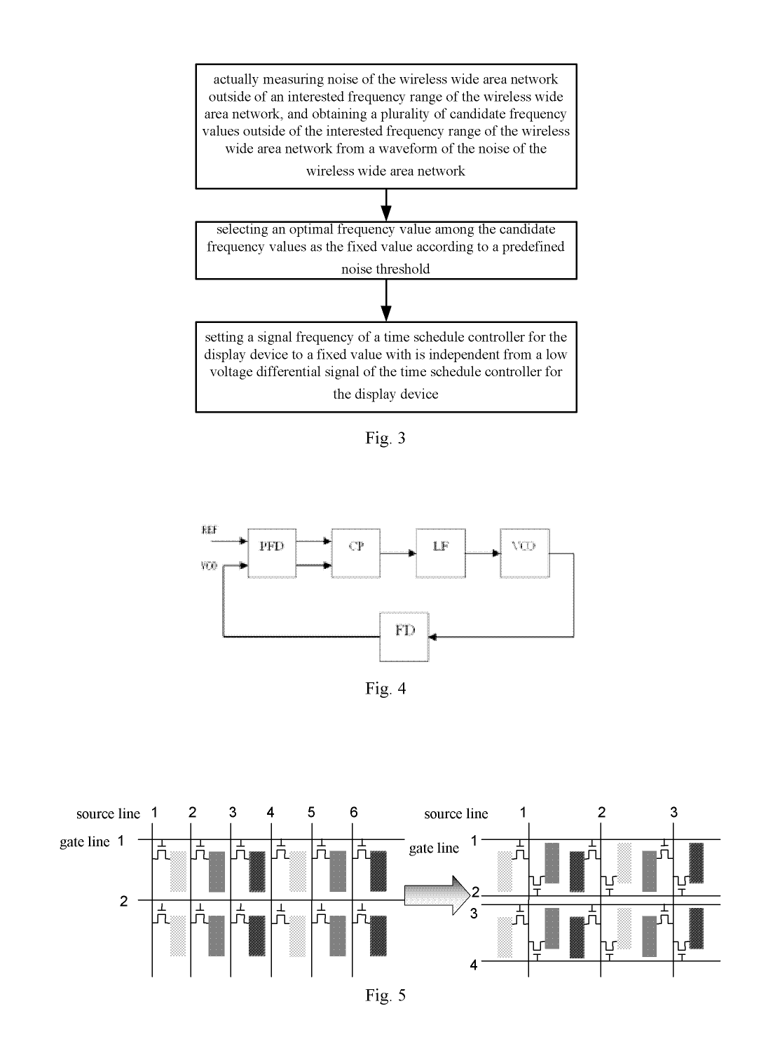

Furthermore, when the present invention is implemented, one PLL circuit may be omitted for the system circuit so as to decrease the cost. In particularly, the relationship between the clock frequency of the time controller and that of the LVDS signal is implemented by a PLL circuit. The PLL circuit is a phase locked circuit, which can be deemed to be a loop circuit, and its output phase and input phase are synchronized so as to synchronize the input reference signal and the feedback output signal. As shown in FIG. 4, the PLL circuit is constituted of five modules of a phase/frequency detector (PFD), a charge pump (CP), a loop filter (LF), a voltage controlled oscillator (VCO) and a frequency divider (FD). The PLL circuit converts the result detected by the phase/frequency detector into a signal in form of voltage to control a phase of the voltage controlled oscillator. Thus, it is obvious that the present invention may omit one PLL circuit by relationship between the clock frequency of the LVDS signal and that of the signal of the time controller, thereby decreasing the cost.

Furthermore, most of the current notebook computer employs a dual-gate design, as show FIG. 5. In such a technical solution, the number of the gate lines is doubled and the number of the source line is halved so as to decrease cost. When the dual-gate design is utilized, two gate lines are needed for one line of data.

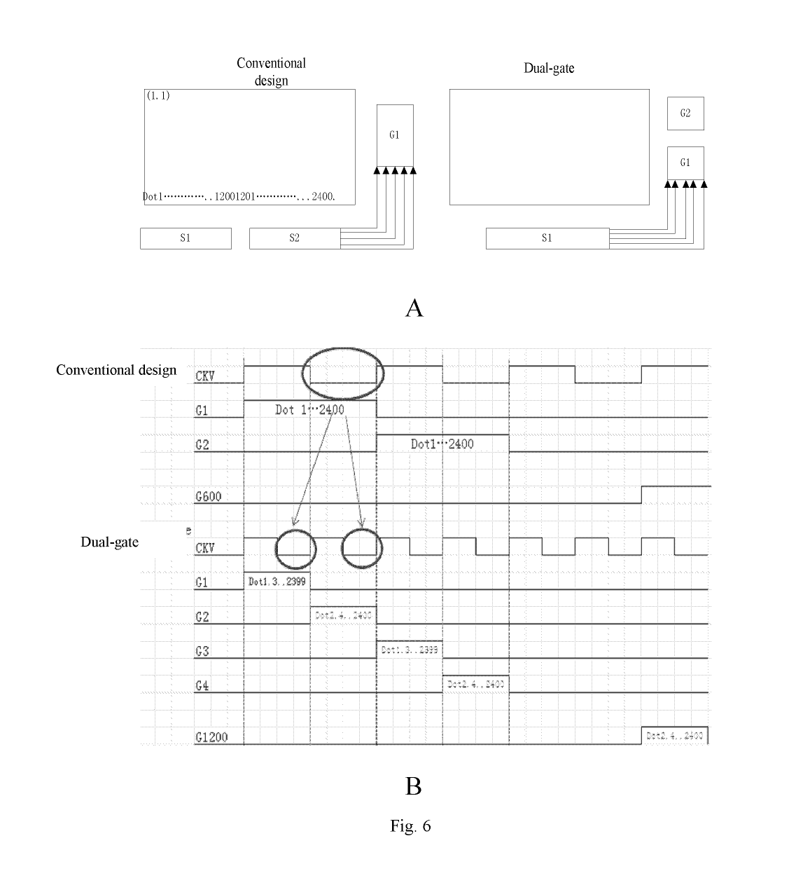

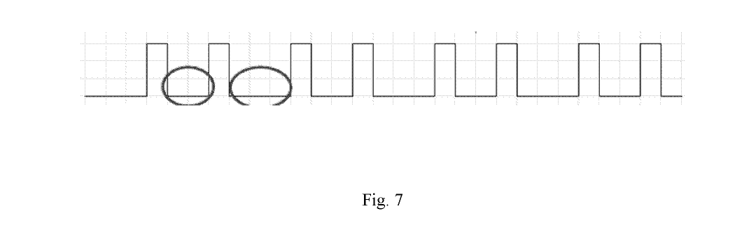

FIG. 6 is a schematic diagram showing a comparison of time schedule charts of a conventional design and a dual-gate design. As can be clearly seen from FIG. 6 that the difference between the conventional design and the dual-gate design only lies in one line of data for the conventional design is divided into two portions which correspond to respective positions for the dual-gate design.

The implementation and technical effect of the present invention would be further illustrated by taking the dual-gate design as an example. As mentioned above, the present invention sets the signal frequency of a time controller to a fixed value so that such a signal frequency can't change along with changes of the frontend signal frequency. In such a case, if the frequency of the frontend LVDS signal is small, i.e. LVDS CLK Frequency *3<Mini-LVDS CLK Frequency, a dummy signal may be artificially inserted between the odd and even gate lines in the dual gate design. Thus, there may be two dummy signals for every line of the signals during transmission of the signal, which comprises a front dummy signal and a back dummy signal. In actual applications, the front dummy signal may be different from the back dummy signal, as shown in FIG. 7b.

In general, the frequency value of the signal of time controller (i.e. the mini-LVDS signal) may set according to the following equation:

F t x=K*(H active+H blank)*(V active+V blank)*F refresh,

wherein Ftx represents the signal frequency of the time controller, K represents a constant, H active represents the number of the valid pixels along a horizontal direction of the display device, H blank represents the number of the blank pixels along the horizontal direction of the display device, V active represents the number of the valid pixels along a vertical direction of the display device, H blank represents the number of blank pixels along the vertical direction of the display device, and F fresh represents a refresh frequency of the display device.

The object of the present invention is to guarantee that the frequency F tx of the signal of the time controller in the above equation is maintained not to be changed. The number of the valid pixels along the horizontal direction of the display device, H active, and the number of the valid pixels along the vertical direction of the display device, V active is fixed. As can be seen from the above equation, when the refresh frequency Frefresh at right side of the equal sign in the above equation is changed, if the frequency F tx of the signal of the time controller is maintained to be fixed, then only the number of the blank pixels along the horizontal direction of the display device H blank and/or the number of the blank pixels along the vertical direction of the display device may be changed. As can be seen from the above description, the blank region constituted of the blank pixels of the display device is constituted of a front dummy signal and a back dummy signal. For one line of signals, if the number of the front dummy signals is fixed, then the number of the back dummy signals would be changed. Thus, the regions of the adjacent falling edges within one line of signal are different, as shown by the circles in FIG. 7. In specific application, the alternation of the size of the blank regions may be done by changing the number of the back dummy signals.

The present disclosure may achieve the following objectives: even if the clock frequency of the frontend LVDS signal changes, the clock frequency of the signal of the backend time controller is kept not to be changed without being affected by the frequency of the frontend LVDS signal. When the WWAN measurement encounters noise caused by the signal of the time controller, an optimal frequency of the signal of the time controller may be obtained by calculation or actual measurement and then the frequency of the signal of the time controller is set to be such a fixed value, so as to avoid the interested frequency range of the WWAN noise. Meanwhile, one PLL circuit is omitted for the whole system circuit so as to decrease the cost.

While the embodiments of the present invention have been described above, the scope of the present invention is not limited to these embodiments. Those skilled in the art can make further modifications and changes to these embodiments without departing from the scope of the present invention. These modifications and changes are to be encompassed by the scope of the present invention. Therefore, the scope of the present invention is defined only by the claims as attached.

1-15. (canceled)

16. A signal frequency setting device for a time controller of a display device, comprising:
a frequency setting module configured to set a signal frequency of the time controller for the display device to a fixed value which is independent from a low voltage differential signal of the time controller for the display device.

17. The signal frequency setting device according to claim 16, further comprising:
a measuring module configured to actually measure noise of a wireless wide area network outside of an interested frequency range of the wireless wide area network, and to obtain a plurality of candidate frequency values outside of the interested frequency range of the wireless wide area network from a waveform of the noise of the wireless wide area network; and
a frequency selecting module configured to select an optimal frequency value among the candidate frequency values as a fixed value according to a predefined noise threshold.

18. The signal frequency setting device according to claim 17, wherein the signal frequency of the time controller is set according to the following equation:
F t x=K*(H active+H blank)*(V active+V blank)*F refresh,
wherein Ftx represents the signal frequency of the time controller, K represents a constant, H active represents the number of valid pixels along a horizontal direction of the display device, H blank represents the number of blank pixels along a horizontal direction of the display device, Vactive represents the number of valid pixels along a vertical direction of the display device, Hblank represents the number of blank pixels along a vertical direction of the display device, and F fresh represents a refresh frequency of the display device.

19. The signal frequency setting device according to claim 17, wherein the frequency setting module is configured to set the signal frequency of the time controller by setting the number of blank pixels Hblank along the horizontal direction of the display device and the number of blank pixels Vblank along the vertical direction of the display device, so that Ftx is kept to be the fixed value.

20. The signal frequency setting device according to claim 19, wherein the frequency setting module is configured to adjust the number of the blank pixels by setting the number of front-dummy signals and back-dummy signals within one line of signals.

21. A display device comprising the signal frequency setting device according to claim 16.

22. A signal frequency setting method for a time controller of a display device, comprising:
setting a signal frequency of the time controller for the display device to a fixed value which is independent from a low voltage differential signal of the time controller for the display device.

23. The signal frequency setting method according to claim 22, prior to setting the signal frequency, further comprising:
actually measuring noise of the wireless wide area network outside of an interested frequency range of the wireless wide area network, and obtaining a plurality of candidate frequency values outside of the interested frequency range of the wireless wide area network from a waveform of the noise of the wireless wide area network; and
selecting an optimal frequency value among the candidate frequency values as the fixed value according to a predefined noise threshold.

24. The signal frequency setting method according to claim 23, wherein the signal frequency of time controller is set according to the following equation:
F t x=K*(H active+H blank)*(V active+V blank)*F refresh,
wherein Ftx represents the signal frequency of the time controller, K represents a constant, Hactive represents the number of valid pixels along a horizontal direction of the display device, Hblank represents the number of blank pixels along the horizontal direction of the display device, Vactive represents the number of valid pixels along a vertical direction of the display device, Hblank represents the number of blank pixels along the vertical direction of the display device, and Ffresh represents a refresh frequency of the display device.

25. The signal frequency setting method according to claim 9, wherein the signal frequency of the time controller is set by setting the number of blank pixels Hblank along the horizontal direction of the display device and the number of the blank pixels Vblank along the vertical direction of the display device, so that Ftx is kept to be the fixed value.

26. The signal frequency setting method according to claim 25, wherein the number of blank pixels is adjusted by setting the number of front-dummy signals and back-dummy signals within one line of signals.

27. A display device comprising the signal frequency setting device according to claim 17.

28. A display device comprising the signal frequency setting device according to claim 18.

29. A display device comprising the signal frequency setting device according to claim 19.

30. A display device comprising the signal frequency setting device according to claim 20.
